(19) United States
(12) Patent Application Publication
(10) Pub. No.: US 2008/0154851 A1
(43) Pub. Date: Jun. 26, 2008

(54) METHOD AND APPARATUS FOR SHARING FILES OVER A NETWORK

(75) Inventor: Sebastien A. Jean, Irvine, CA (US)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/614,817

(22) Filed: Dec. 21, 2006

(51) Int. Cl. G06F 17/30; G06F 15/16

(52) U.S. Cl. 707/3; 709/205; 707/101; 707/E17.014; 707/E17.002

(57) ABSTRACT

Embodiments of the present invention can provide means of publicly sharing large files of personal and limited interest over a network. Pursuant to these embodiments, a file possessed by a peer on a network, is shared with another peer on the network by fragmenting the file into data blocks smaller than the original file and transferring these data blocks to other peers on the network where a recipient peer searches for and downloads them.

### BACKGROUND OF THE INVENTION

1. Field of the Invention

The present invention relates to peer-to-peer networks, more specifically, the present invention is for sharing files efficiently over a peer-to-peer network with a set of users.

2. Description of the Related Art

The distribution of centralized resources and content has been a problem plaguing users of the Internet since its creation. As the popularity of digital lifestyle devices such as mp3 players and digital still and video cameras grows, so does the need for providing an efficient means of distributing these files. These files have been growing not only in number but also in size. The demand for high-definition quality music and video, along with life-like pictures and images, has led to average file sizes from these digital lifestyle devices growing almost two-fold.

Peer-to-peer (P2P) network computing has been a popular means of decentralizing and distributing resources and content over the internet. P2P networks do not use literal clients or servers. Instead, they utilize nodes that simultaneously function as both clients and servers to the other nodes on the network. Current file sharing networks such as EDonkey™, FastTrack™, and Gnutella™ utilize P2P networks to primarily exchange music, video and software. In these instances, content is decentralized and exchanged directly between users on the P2P network. Another key feature of P2P networks is the ability to allow a large number of users to search freely for files available on the network. This feature works best when there are numerous users interested in the same file because of the replication rate of the file and multiple instances of it on the network after replication.

Although P2P networks have proven to be a successful means of decentralizing and distributing files, it does not come without its disadvantages. P2P networks rely on the file being shared to be of interest to many users to allow load balancing. The demand for, and acquisition of the file by users, allows the file to be replicated and therefore hosted by multiple nodes. In cases where there is content such as personal audio, video or images, interest is limited to only those users that have some connection or concern in that personal file. Because of this limited interest, files are not frequently downloaded. Therefore, these files are not as readily available on the network as those of public popularity. Without the replication and availability of the file, the advantages of a P2P network are obviated reducing load sharing, decentralization, and thus distribution.

### SUMMARY OF THE INVENTION

The present invention has been actualized to resolve the abovementioned problem, and an aspect thereof is to provide a file sharing method, apparatus, and program that allows sharing of files publicly over a network.

To accomplish the aspect above, an embodiment of the invention provides a method for sharing a file over a network comprising: dividing a file to be shared into a first data block and a second data block; attaching a first header to the first data block, the first header including information associated with the file and information associated with the first data block; attaching a second header to the second data block, the second header including information associated with the file and information associated with the second data block; storing the first data block with the first header attached thereto in a first device coupled to the network such that less than an entire portion of the file to be shared is stored in the first device; and storing the second data block with the second header attached thereto in a second device coupled to the network such that less than an entire portion of the file to be shared is stored in the second device.

Further features and advantages of the present invention will become apparent from the following description of exemplary embodiments (with reference to the attached drawings).

### BRIEF DESCRIPTION OF THE DRAWINGS

FIG. 1 is a block diagram of a system for sharing a file according to an embodiment of the present invention.

FIG. 2 illustrates a block diagram of a peer according to an embodiment of the present invention.

FIG. 3 is an illustration of a block diagram of an original host peer preparing to share a file according an embodiment of the present invention.

FIG. 4 is a block diagram of an auxiliary host peer used to host portions of a file according to an embodiment of the present invention.

FIG. 5 illustrates a block diagram of a requesting client peer searching for a file according to an embodiment of the present invention.

### DESCRIPTION OF THE EMBODIMENTS

Embodiments of the present invention can provide means of publicly sharing large files of personal and limited interest over a network. Pursuant to these embodiments, a file possessed by a device on a network, is shared with another device on the network by fragmenting the file into data blocks smaller than the original file and transferring these data blocks to other peers on the network where a recipient device searches for and downloads them. The method enables network devices with limited uplink capabilities, the ability to publicly share large personal media files including, but not limited to, high quality music, video, and images.

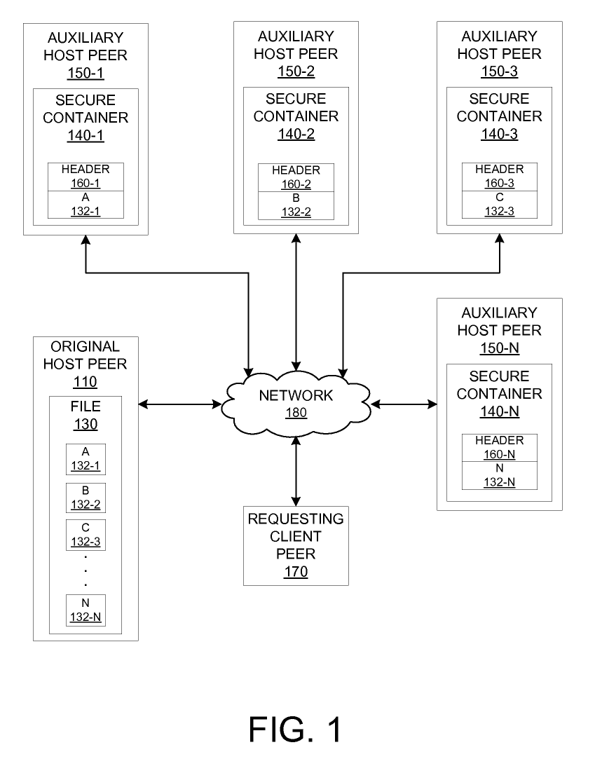

FIG. 1 is a block diagram of a system for sharing a file according to an embodiment of the present invention. The system includes an original host peer 110, a requesting client peer 170, and at least one auxiliary host peer 150 each communicatively coupled to a network 180. Respecting the nature of a P2P network, peer designations are variable and the roles of each peer can change anytime in respect to sending or receiving. Designations are merely for explanation purposes and in no way limits a peer's function.

In an embodiment of the present invention, the original host peer 110, requesting client peer 170, and all network connected auxiliary host peers 150, contain identical client software. In general, peers are, but not limited to, personal computers and/or digital lifestyle devices such as digital still image cameras, digital video cameras, digital music players, and digital reading/display devices that are communicatively coupled to the network 180.

The network 180 can be any network allowing transport of data by any means between the peers. In general, data can take the form of, but is not limited to, images, video, and music. The network 180 can be private or public, wired or wireless, in whole or in part.

The original host peer 110 is communicatively coupled to the network 180 and contains a file 130 to be shared on the network 180 with at least one requesting client peer 170. To do so, it will prepare the file 130 by fragmenting the file 130 into blocks 132 that will be transferred to auxiliary host peers 150 along with a unique header 160 added to each block 132. It will then search for appropriate auxiliary host peers 150 on the network 180 and transfer the blocks 132 accordingly into the auxiliary host peers' 150 secure containers 140. In addition, the original host peer 110 does not require authorization from the prospective auxiliary host peers 150 to transfer blocks 132 into its secure container 140.

The auxiliary host peers 150 are identical in that each is communicatively coupled to the network 180 and contains a secure container 140 that will receive and store blocks 132 from the original host peer 110. The secure containers 140 are accessed by the original host peer 110 without a request or need for approval by the receiving auxiliary host peer 150.

The requesting client peer 170 is communicatively coupled to the network 180 and initiates a search for the file 130 on the network 180. It will search for the blocks 132 of the file 130 within auxiliary host peers 150 connected to the network 180. In another embodiment, it will search for the blocks 132 of the file 130 within the original host peer 110 itself. When needed blocks 132 are found, the requesting client peer 170 will request the transfer of the blocks 132 from their present location. Upon collection of all needed blocks 132 it will reassemble the blocks 132 by reading each block's 132 header 160 to form the complete original file 130 allowing the user of the requesting client peer 170 to use the file 130.

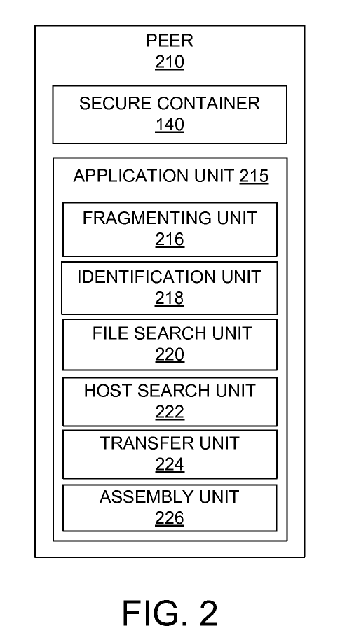

FIG. 2 illustrates a block diagram for the software architecture of a peer 210 according to one embodiment of the invention. In general, a device's role with the appropriate client software, communicatively coupled to the network, is variable and can act as, but is not limited to, an original host peer 110, auxiliary host peer 150, or requesting client peer 170. The software architecture of the peer 210 includes a secure container 140 and an application unit 215. Hardware elements of the peer including, but not limited to, microprocessors, memory, storage devices, buses, etc., are not shown but can be of any conventionally available or equivalent design.

The secure container 140 may be software or hardware and/or any combination thereof. The secure container 140 stores file blocks 132 to be transferred between peers 210 communicatively coupled to the network 180. The secure container 140 is not accessible by the peer user and its contents are unknown to the peer user. In addition, the peer 210 in which the secure container 140 resides does not need to authorize access to it by other peers 210 communicatively coupled to the network 180. Other peers 210 on the network 170 are able to freely send and receive data stored in the secure container 140.

Moreover, the application unit 215 may be software or hardware and/or any combination thereof. The application unit 215 includes a fragmenting unit 216, identification unit 218, file search unit 220, host search unit 222, transfer unit 224, and assembly unit 226. The fragmenting unit 216 is utilized when the peer 210 has a file 130 to be shared. It takes the file 130 and fragments it into blocks 132. In another embodiment, the fragmenting unit 216 encrypts the original file 130 after it fragments it into blocks 132.

The identification unit 218 takes blocks 132 that the fragmenting unit 216 has created and attaches appropriate headers 160 to each. This allows searchable information about the file 130 to be added to each block 132. For example, added headers 160 may include, but are not limited to, searchable metadata, appropriate blocks 132 needed to reassemble the complete file 130, security attributes, and/or number of times file block 132 was previously copied.

The file search unit 220, searches the network 180 for peers 210 with whole files and/or file blocks 132 of a particular file 130 by reading information from the file 130 itself or from headers 160 attached to file blocks 132 by the identification unit 218. In another embodiment, the file search unit 220 only searches headers 160 of encrypted file blocks 132 by obtaining an encryption key from the original host peer 110.

The host search unit 222, searches for appropriate auxiliary host peers 150 communicatively coupled to the network 180 to transfer file blocks 132 created by the fragmenting unit 216. In another embodiment, the host search unit 222 may search for appropriate auxiliary host peers 150 communicatively coupled to the network 180 to transfer file blocks 132 within a secure container 140.

The transfer unit 224 sends and receives required file blocks 132 to and from one or more sources. Sources may include, but are not limited to, the secure container 140 of other peers 210 and localized memory of other peers 210.

The assembly unit 226, assembles file blocks 132 received by the transfer unit 224 by using information in the headers 160 of each block 132 attached by the identification unit 218.

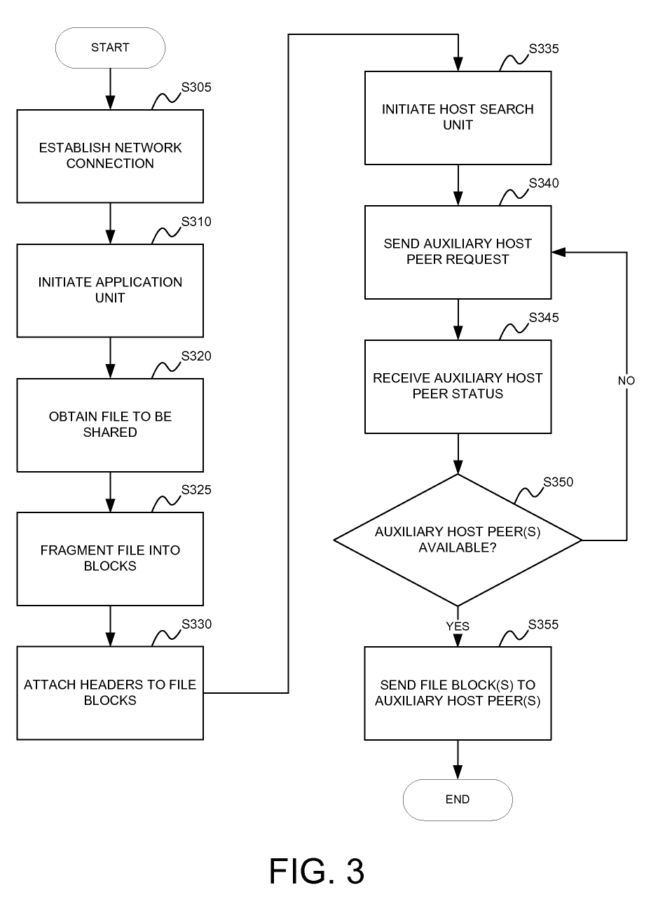

FIG. 3 is an illustration of a block diagram of an original host peer 110 preparing to share a file according an embodiment of the present invention. The original host peer 110 begins by establishing S305 a connection to the network 170.

Next, the original host peer 110 initiates S310 the application unit 215 to allow sharing of a file 130. The fragmenting unit 216 then obtains S320 the file 130 to be shared from local storage means on the original host peer 110 to prepare the file 130 for fragmenting. Once the fragmenting unit 216 obtains the file 130, it fragments S325 the file into blocks 132 of smaller size than the original file 130. Afterwards, the identification unit 218 attaches S330 headers 160 to each file block 132 created by the fragmenting unit 216 to allow future identification and assembly.

After all blocks 132 have been properly identified and their respective headers 160 attached, the original host peer 110 will initiate S335 the host search unit 222 to allow a search for auxiliary host peers 150 on the network 180. The host search unit 222 will then send S340 an auxiliary host peer request over the network 180 that will be answered by available peers 210. Peers 210 present on the network 180 will send their current status in response to the auxiliary host peer 150 request and the host search unit 222 will receive S345 the answer. Upon receipt of the answer, the original host peer 110 will resolve whether auxiliary S350 host peers are available on the network 180. If appropriate auxiliary host peers 150 are available, the transfer unit 224 will send file blocks 130 to the respective auxiliary host peers 150. Otherwise, the host search unit 222 will send S355 another auxiliary host peer request over the network 180 and continue accordingly.

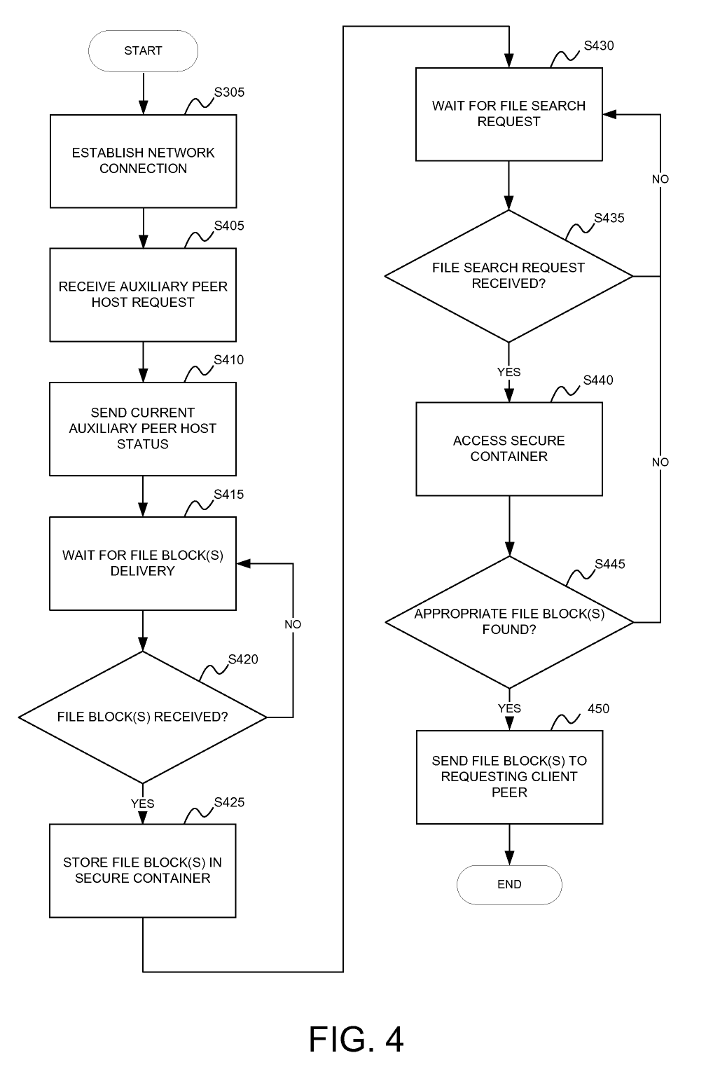

FIG. 4 is a block diagram of an auxiliary host peer 150 used to host portions of a file according to an embodiment of the present invention. The auxiliary host peer 150 begins by establishing S305 a connection to the network 180.

Hosting begins with the auxiliary host peer 150 receiving S405 an auxiliary host peer request from an original host peer 110 connected to the network 180. Upon receipt of this request, the auxiliary host peer 150 sends S410 its current status, as to hosting availability, to the original host peer 110. In another embodiment, the auxiliary host peer 150 receives an auxiliary host peer request from any type of peer 210 connected to the network 180 and correspondingly sends its current status as to hosting availability to this peer 210.

Next, the auxiliary host peer 150 waits S415 for delivery of any file blocks 132. If file blocks 132 are received S420, the transfer unit 224 will store S425 the received file blocks 132 into the auxiliary host peer's 150 secure container 140. Otherwise, the auxiliary host peer 150 continues to wait S415 for delivery of file blocks 132.

Once file blocks 132 have been placed in the secure container 140, the auxiliary host peer 150 will wait S430 for a file search request from a requesting client peer 170 connected to the network 180. In another embodiment, the auxiliary host peer 150 will wait S430 for a file search request from any type of peer 210 connected to the network 180.

If a file search request is received, the auxiliary host peer 150 will access S440 its secure container 140. Otherwise, the auxiliary host peer 150 will continue to wait S430 for a file search request. After accessing S440 its secure container 140, the auxiliary host peer 150 checks whether the appropriate file blocks 132 are found S445. If appropriate file blocks 132 are found, the transfer unit 224 will send S450 the needed file blocks 132 to the requesting client peer 170. In another embodiment, if appropriate file blocks 132 are found, the transfer unit 224 will send S450 the needed file blocks 132 to any peer 210 connected to the network 180. Otherwise, the auxiliary host peer 150 returns to waiting S430 for a file search request.

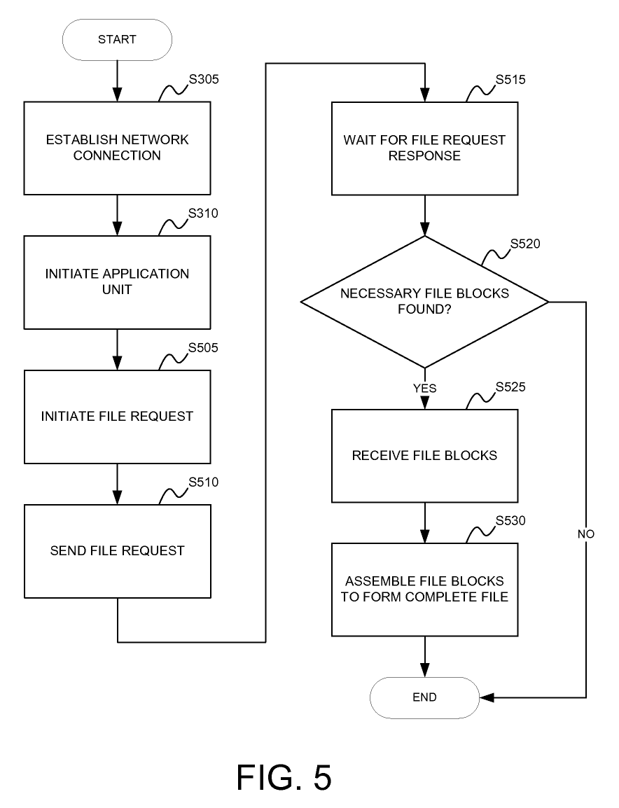

FIG. 5 illustrates a block diagram of a requesting client peer 170 searching for a file 130 according to an embodiment of the present invention. The requesting client peer 170 begins by establishing S305 a connection to the network 180.

Next, the requesting client peer 170 initiates S310 the application unit 215 to allow sharing of a file 130. The file search unit 220 then initiates S505 a file request in response to user input at the requesting client peer 170. Afterwards, the file search unit 220 sends S510 a file request over the network 180 to search for needed file blocks 132.

The requesting client peer 170 then waits S515 for a file request response from auxiliary host peers 150 on the network 180. In another embodiment, the requesting client peer 170 then waits S515 for a file request response from any peer 210 on the network 180.

The file search unit 220 then resolves whether the necessary S520 file blocks 132 have been found. If the file blocks 132 are found, the transfer unit 224 receives S525 the necessary file blocks 132 from peers 210 on the network 180. Otherwise, the request for a file is terminated.

After receiving all necessary file blocks 132, the assembly unit 226 assembles S530 the file blocks 132 to form the complete file 130 making it available for use by the requesting client peer 170.

In short, an embodiment of the invention allows sharing of files of limited interest and availability publicly between users in the system. The application unit 215 allows participating peers 210 on the network 180 to act as hosts for portions of a file instead of a whole file, saving storage space on a hosting peer. This feature allows increased sharing potential of a file since complete file possession is not necessary to participate as a hosting peer on a network. Additionally, the secure container 140 of peers 210 does not require approval to store portions of the shared file 130. Authorization for storage of these file blocks 132 is granted upon participation in the system. This feature allows every peer 210 in the system to potentially be an auxiliary hosting peer 150 increasing availability of the shared file 130 of limited public interest.

According to an embodiment of the invention, the original host peer transfers data blocks to other host peers without a request for access and, requesting host peers retrieve data blocks from other host peers without a request for access because the hosting peers allow storage and transferring of data blocks as a prerequisite for participation in the network.

According to an embodiment of the invention, the host peers found by the original host, contain a secure container for the storage of data blocks. This secure container is inaccessible by the user of the peer and its contents are unknown to the peer's user. For example, when the original host peer is sharing a video file, the data blocks of the video file stored in host peers cannot be used by the host peers with a video player/reader application. Additionally, the status and identity of data blocks stored in the host peers is unknown to the users of the host peers.

According to an embodiment of the invention, the shared file is labeled private by the original host and the data blocks are encrypted to allow only predetermined users to search and obtain these data blocks.

According to an embodiment of the invention, a peer hosting a portion of a file will search for other peers to copy and transfer its portion to when other peers access the portion of the file frequently.

According to an embodiment of the invention, files are marked private by the original sharing host and can only be accessed by specified users. The file may be protected by a shared secret password or equivalent or by public key-style credentials obtained by the peer through communication with the intended recipient peer.

According to an embodiment of the invention, data blocks are transmitted to and from peers in the background and at off-hours to avoid consuming excess bandwidth.

According to an embodiment of the invention, data blocks contain information that limits the number of times it may be copied and/or transferred. This is to avoid accidental excessive data proliferation. Additionally, according to an embodiment of the invention, data blocks are aged out from peer storage when they become stale and are never or rarely accessed.

According to an embodiment of the invention, a recipient peer will download required data blocks from one or more sources on the network to maximize throughput and limit the load on a given host.

According to an embodiment of the invention, a recipient peer may obtain required data blocks from its own local secure container and transfer them to local storage for its own use.

According to an embodiment of the invention, recipient peers notify the original host peer that it could not find required data blocks in other host peers connected to the network.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation to encompass all such modifications and equivalent structures and functions.

What is claimed is:

1. A method for sharing a file over a network, comprising:
dividing a file to be shared into a first data block and a second data block;
attaching a first header to the first data block, the first header including information associated with the file and information associated with the first data block;
attaching a second header to the second data block, the second header including information associated with the file and information associated with the second data block;
storing the first data block with the first header attached thereto in a first device coupled to the network such that less than an entire portion of the file to be shared is stored in the first device; and
storing the second data block with the second header attached thereto in a second device coupled to the network such that less than an entire portion of the file to be shared is stored in the second device.

2. The method of claim 1, further comprising:
searching for the first data block with the first header attached thereto in devices coupled to the network based on the first header to generate a first search result;
searching for the second data block with the second header attached thereto in devices coupled to the network based on the second header to generate a second search result;
retrieving the first data block from the first device based on the first search result;
retrieving the second data block from the second device based on the second search result; and
assembling the retrieved first data block and the retrieved second data block to form the file.

3. The method of claim 1, wherein storing the first data block in the first device does not require permission by the first device, and storing the second data block in the second device does not require permission by the second device.

4. The method of claim 2, wherein retrieving the first data block from the first device does not require permission by the first device, and the second data block from the second device does not require permission by the second device.

5. The method of claim 1, wherein the first device retrieves the first data block stored in a first location of the first device, retrieves the second data block from the second device and, assembles the retrieved second data block and the retrieved first data block in a second location of the first device to form the file.

6. The method of claim 2, further comprising:
generating a notification when search of the first data block fails; and
sending the notification over the network.

7. The method of claim 1, wherein the first data block stored in the first device is inaccessible with an application for use with the file, and the second data block stored in the second device is inaccessible with an application for use with the file.

8. The method of claim 1, wherein the first data block is searchable only by designated devices, and the second data block is searchable only by designated devices.

9. The method of claim 8, wherein the designated devices are designated by invitation.

10. The method of claim 1, wherein the first data block is encrypted before attaching the first header, and the second data block is encrypted before attaching the second header.

11. The method of claim 1, further comprising:
preventing transfer of the first data block if the first data block has been copied more than a defined number of times.

12. The method of claim 1, further comprising:
searching, by the first device, for another device coupled to the network to store the first data block with the first header attached thereto when the first data block is frequently retrieved; and
searching, by the second device, for another device coupled to the network to store the second data block with the second header attached thereto when the second data block is frequently retrieved.

13. The method of claim 1, further comprising:
removing the first data block from the first device after a defined time period since the first data block was last retrieved; and
removing the first data block from the first device when the first data block fails to be retrieved a defined number of times during a defined time period.

14. An apparatus for sharing a file over a network comprising:
a fragmenting unit configured to divide a file to be shared into a first data block and a second data block; and
an identification unit configured to attach a first header to the first data block and attach a second header to the second data block, where the first header includes information associated with the file and information associated with the first data block and the second header includes information associated with the file and information associate with the second data block.

15. The apparatus of claim 14, further comprising:
a file search unit configured to search for the first data block with the first header attached thereto in devices coupled to the network based on the first header to generate a first search result and to search for the second data block with the second header attached thereto in devices coupled to the network based on the second header to generate a second search result;
a transfer unit configured to retrieve the first data block from the first device based on the first search result and to retrieve the second data block from the second device based on the second search result;
an assembly unit configured to assemble the retrieved first data block and retrieved second data block to form the file.

16. The apparatus of claim 14, wherein the transfer unit is capable of storing the first data block in the first device without obtaining permission from the first device, and the transfer unit is capable of storing the second data block in the second device without obtaining permission from the second device.

17. The apparatus of claim 15, wherein the transfer unit is capable of retrieving the first data block from the first device without obtaining permission from the first device, and the transfer unit is capable of retrieving the second data block from the second device without obtaining permission from the second device.

18. The apparatus of claim 15, wherein the transfer unit retrieves the first data block stored in a first location of the first device, the transfer unit retrieves the second data block from the second device and, the assembly unit of the first device assembles the second data block and the first data block in a second location of the first device to form the file.

19. The apparatus of claim 15, wherein the file search unit generates a notification when search of the first data block fails and the file search unit sends the notification over the network.

20. The apparatus of claim 15, wherein the file search unit is allowed to search for the first data block only when designated, and the file search unit is allowed to search for the second data block only when designated.

21. The apparatus of claim 20, wherein the file search unit is designated by invitation.

22. The apparatus of claim 14, wherein the identification unit encrypts the first data block before attaching the first header, and the identification unit encrypts the second data block before attaching the second header.

23. The apparatus of claim 14, wherein the identification unit limits the number of times the first data block is capable of being transferred.

24. The apparatus of claim 14, wherein the identification unit limits the number of times the first data block is capable of being copied.

25. The apparatus of claim 14, further comprising:
a host search unit configured to search for at least one device coupled to the network to store the first data block with the first header attached thereto when the first data block is frequently retrieved from the first device; and
a host search unit configured to search for at least one device coupled to the network to store the second data block with the second header attached thereto when the second data block is frequently retrieved from the second device.

26. The apparatus of claim 14, wherein the identification unit removes the first data block from the first device when the first data block has not been retrieved a defined number of times.

27. The apparatus of claim, 14 wherein the identification unit removes the first data block from the first device after a defined period of time has passed since the first data block was last retrieved.

28. A computer-readable medium storing instructions which, when executed by an apparatus, causes the apparatus to perform the operations comprising:
dividing a file to be shared into a first data block and a second data block;
attaching a first header to the first data block, the first header including information associated with the file and information associated with the first data block;
attaching a second header to the second data block, the second header including information associated with the file and information associated with the second data block;
transferring, the first data block with the first header attached thereto to a first device coupled to the network such that less than an entire portion of the file to be shared is stored in the first device; and
transferring, the second data block with the second header attached thereto to a second device coupled to the network such that less than an entire portion of the file to be shared is stored in the second device.

29. The computer-readable medium of claim 28, wherein the operations further comprises:
searching for the first data block with the first header attached thereto in devices coupled to the network based on the first header to generate a first search result;
searching for the second data block with the second header attached thereto in devices coupled to the network based on the second header to generate a second search result;
retrieving the first data block from the first device based on the first search result;
retrieving the second data block from the second device based on the second search result; and
assembling the retrieved first data block and retrieved second data block to form the file.
